(19) United States
(12) Patent Application Publication
(10) Pub. No.: US 2025/0115361 A1
(43) Pub. Date: Apr. 10, 2025

(54) METHODS OF SCRUBBING CABIN AIR AND ENGINE BLEED AIR IN ENVIRONMENTAL CONTROL SYSTEM OF AN AIRCRAFT

(71) Applicant: AeroParts Manufacturing & Repair, Inc., Rio Rancho, NM (US)

(72) Inventors: Richard B. Fox, Queen Creek, AZ (US); Larry B. Britt, Corrales, NM (US)

(73) Assignee: AeroParts Manufacturing & Repair, Inc., Rio Rancho, NM (US)

(21) Appl. No.: 18/911,110

(22) Filed: Oct. 9, 2024

Related U.S. Application Data
(60) Provisional application No. 63/589,006, filed on Oct. 9, 2023.
(60) Provisional application No. 63/592,044, filed on Oct. 20, 2023.
(60) Provisional application No. 63/682,170, filed on Aug. 12, 2024.

(51) Int. Cl. B64D 13/06

(52) U.S. Cl. CPC B64D 13/06; B64D 2013/0618; B64D 2013/0651; B64D 2013/0685

(57) ABSTRACT

Methods for scrubbing air, specifically engine bleed air and recirculated air, in an environmental control system in an aircraft. A volatile organic compound (VOC) and aerosol catalytic converter is added at different locations in the environmental control system in order to maximize the removal of harmful contaminants prior to the air being introduce, or re-introduced, to the air plane cabin. Filter membranes may also be placed throughout the environmental control system to be used in conjunction with the volatile organic compound (VOC) and aerosol catalytic converter.

### CROSS-REFERENCE TO RELATED APPLICATIONS

This application claims the benefit of the following U.S. Provisional Patent Applications: Ser. No. 63/589,006 filed Oct. 9, 2023, titled “CABIN AIR AND ENGINE BLEED AIR CONTROL SYSTEM FOR AN AIRCRAFT”; Ser. No. 63/592,044 filed Oct. 20, 2023, titled “CABIN AIR AND ENGINE BLEED AIR CONTROL SYSTEM FOR AN AIRCRAFT”; and Ser. No. 63/682, 170 filed Aug. 12, 2024, titled “CABIN AIR AND ENGINE BLEED AIR CONTROL SYSTEM FOR AN AIRCRAFT”, and the subject matter thereof is incorporated herein by reference thereto.

### TECHNICAL FIELD

The present invention relates to air control systems, and more specifically, an environmental control system for cabin air and engine bleed air in an aircraft.

### PRIOR ART

During flight, air enters the engines. Some of the air from the engines does not enter the combustion chambers and is redirected from the engine to other parts of the aircraft. This is the engine bleed air, and it is at a very high temperature. Typically, the engine bleed air must then enter a pre-cooler unit before it is directed outside the engine pylon for use in the aircraft pneumatic system.

The engine bleed air may contain compounds that could be considered harmful for the users of the environmental control system or for materials in the fuel tank inerting system. Most of the prior art is not focused on removing undesired substances or objectionable odors from the air in the system, but rather utilizing sensors to detect and isolate the source when there is a contamination event. One of the greatest barriers to implementing adaptive environmental controls into the environmental control system (may be referred to as an “ECS”) of an aircraft has been what to do about elevated levels of carbon dioxide and recirculated cabin human bioeffluents and VOC contaminants that are in the aircraft cabin recirculated air. There could be potential cognitive performance issues for flight crew if carbon dioxide levels were elevated by as little as 500 ppm above the current ambient background level of approximately 400 ppm. As such, it is very important to monitor and control the levels of volatile organic compounds (VOCs) and semi-volatile organic compounds (SVOCs), and carbon dioxide as they can affect human performance. There is potential for additional energy savings and reduced carbon emissions through the use of VOC removal devices in the recirculated cabin air.

The present invention overcomes the shortcomings contained in the prior art by providing a method of scrubbing the air to remove VOCs, irritant compounds, objectionable odors, oil aerosol, and other harmful contaminants in an environmental control system. The present invention is reliable, effective, cost saving, and able to be retrofitted to existing environmental control system. None of the prior art fully addresses the problems resolved by the present invention.

The present invention does not require complex monitoring and control algorithms, as do much of the prior art.

### BRIEF DESCRIPTION OF DRAWINGS

FIG. 1 illustrates a block diagram of an environmental control system.

FIG. 2 illustrates a block diagram of an environmental control system showing the components of the air conditioning subsystem.

FIG. 3 illustrates a block diagram of an environmental control system showing the components of the air conditioning subsystem and the shaft.

FIG. 4 illustrates a block diagram of an environmental control system 101 with a VOC and aerosol catalytic converter of the present invention located in between the compressor and the second heat exchanger in an environmental control system

FIG. 5 illustrates a block diagram of an environmental control system with a VOC and aerosol catalytic converter of the present invention located in between the ozone converter and the first heat exchanger.

FIG. 6 illustrates a block diagram of an environmental control system with a VOC and aerosol catalytic converter of the present invention located in between the air heat exchanger and the cabin air mix manifold.

### DETAILED DESCRIPTION OF THE INVENTION

The best mode for carrying out the invention will be described herein. The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. To avoid obscuring the present invention, some well-known system configurations, and process steps are not disclosed in detail. The figures illustrating embodiments of the system, if any, are semi-diagrammatic and not to scale and, particularly, some of the dimensions are for the clarity of presentation and are shown exaggerated in the drawing figures.

Alternate embodiments have been included throughout, and the order of such are not intended to have any other significance or provide limitations for the present invention.

For expository purposes, the term “horizontal” as used herein is defined as a plane parallel to the plane or surface of the present apparatus, regardless of its orientation. The term “vertical” refers to a direction perpendicular to the horizontal as just defined. Terms, such as “above”, “below”, “bottom”, “top”, “side”, “higher”, “lower”, “upper”, “over”, and “under”, are defined with respect to the horizontal plane, as shown in the figures, if any. The term “on” means that there is direct contact among elements.

The term “fluid” as used herein includes any substance that flows, including air. The term “VOC” refers to volatile organic compounds and “SVOC” refers to semi-volatile organic compounds. Accordingly, “VOC and aerosol catalytic converter” may be referred to as “volatile organic compound and aerosol catalytic converter.”

The present invention provides a method of scrubbing engine bleed air in an environmental control system. A VOC and aerosol catalytic converter is added at different locations in the environmental control system. The air that enters the VOC and aerosol catalytic converter varies based on the placements in the environmental control system. As such, the present invention provides multiple embodiments of scrubbing engine bleed air in an environmental control system based on the composition of the air due to the different locations of the VOC and aerosol catalytic converter. Although engine bleed air is used in this instance, in one embodiment, clean recirculated air is what flows through VOC and aerosol catalytic converter.

The present invention provides a method of scrubbing engine bleed air in an environmental control system, comprising the steps of: flowing the engine bleed air into an air conditioning subsystem, wherein the engine bleed air is cooled and compressed; and flowing the engine bleed air through a VOC and aerosol catalytic converter, wherein the VOC and aerosol catalytic converter captures and removes contaminants, and wherein the engine bleed air is released through the rest of the environmental control system.

The present invention further comprises a method of scrubbing engine bleed air in an environmental control system wherein the temperature of the engine bleed air entering the VOC and aerosol catalytic converter is between 250-400 F; and wherein the pressure of the engine bleed air entering the VOC and aerosol catalytic converter is between 45-60 PSIA.

The present invention provides a method of scrubbing engine bleed air in an environmental control system, comprising the steps of: removing ozone in the engine bleed air; and flowing the engine bleed air through a VOC and aerosol catalytic converter, wherein the VOC and aerosol catalytic converter captures and removes contaminants, wherein the engine bleed air is released through the rest of the environmental control system.

The present invention further comprises a method of scrubbing engine bleed air in an environmental control system wherein the temperature of the engine bleed air entering the VOC and aerosol catalytic converter is between 250-400 F; and wherein the pressure of the engine bleed air entering the VOC and aerosol catalytic converter is between 45-60 PSIA.

The present invention provides a method of scrubbing clean recirculated air in an environmental control system, comprising the steps of: compressing recircuited air via an air compressor to created compressed recirculated air; flowing the compressed recirculated air through an air heat exchanger that contains a water removal membrane, a VOC adsorbent, and a low temperature VOC catalyst to create clean recirculated air; and flowing the clean recirculated air through a VOC and aerosol catalytic converter, wherein the VOC and aerosol catalytic converter captures and removes contaminants, and wherein the clean recirculated air is released back into a cabin air mix manifold.

The present invention further comprises a method of scrubbing engine bleed air in an environmental control system wherein the air compressor is shaft driven or electrically driven; wherein the temperature of the clean recirculated air entering the VOC and aerosol catalytic converter is between 75-100 F; and wherein the pressure of the clean recirculated air entering the VOC and aerosol catalytic converter is between 8-16 PSIA.

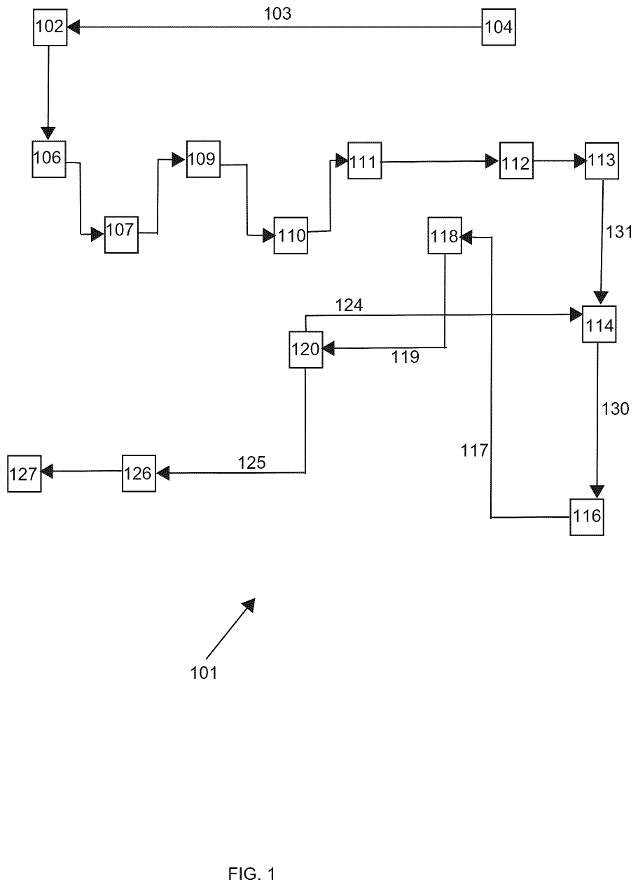

FIG. 1 shows a block diagram of environmental control system 101. Engine 104 creates engine bleed air 103 that flows through ozone converter 102. Ozone converter 102 may comprise an ozone filter, a VOC converter, or other suitable means for converting/filtering ozone, and may have some VOC removal functionality. All references to an ozone converter also comprise the use of a VOC/SVOC converter, as determined by the requirements and desired outcome of the system.

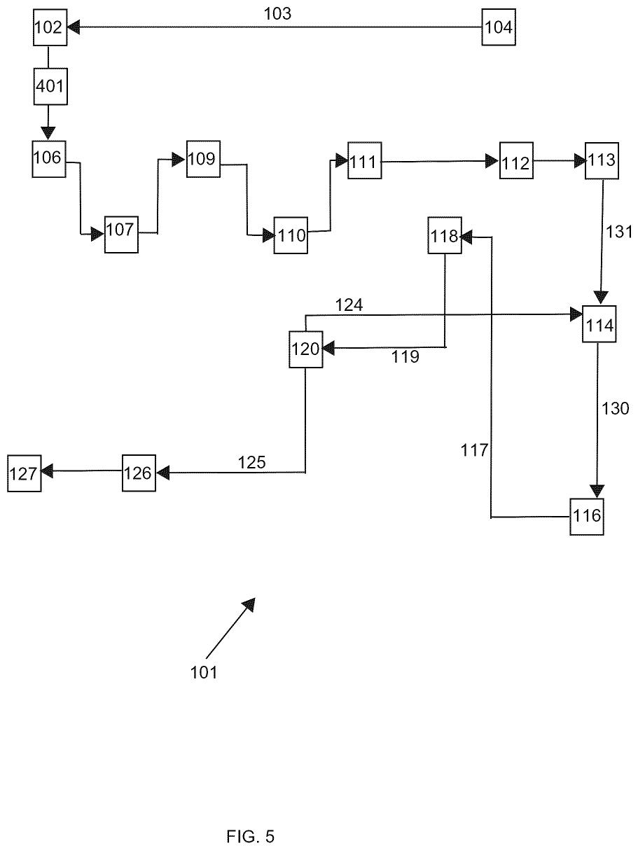

Ozone converter 102 may create odor causing compounds such as carboxylic acids and aldehydes. Some carboxylic acids may create observable odors at very low concentrations. Formaldehyde is an aldehyde that may be generated along with carboxylic acids, and which may be an irritant when breathed. A VOC converter, such as VOC and aerosol catalytic converter 401 as shown in FIG. 5 below, when combined with ozone converter 102, produces lower levels of carboxylic acids and formaldehyde. Bleed air odors may have been lower before regulations were introduced that required controlling bleed air ozone levels below regulatory limits. Limitations of space, pressure drop, and ozone catalyst material may prevent some designs of ozone converter 102 from removing odor causing contaminants and irritants such as formaldehyde. Some aircraft may not have ozone converter 102, and contaminants may enter subsystem 201 without any removal of contaminants.

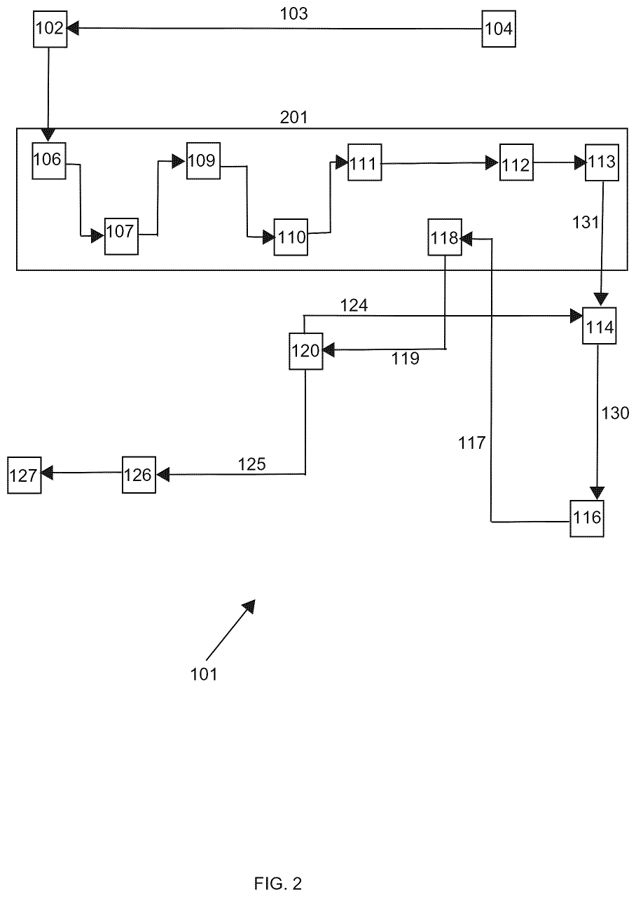

After exiting ozone converter 102, engine bleed air 103 then enters air conditioning subsystem 201 (shown on FIG. 2) and flows through first heat exchanger 106 to control maximum temperature of engine bleed air 103 before it enters compressor 107. Engine bleed air 103 then enters second heat exchanger 109. Engine bleed air 103 is then cooled in turbine 110, reheated in reheater 111, and then passes through condenser 112 and water extractor 113, before exiting the air conditioning subsystem 201 as cool dry air 131. Cool dry air 131 enters cabin air mix manifold 114, where it is blended with clean recirculated air 124.

Clean recirculated air 124 and cool dry air 131 are mixed in cabin air mix manifold 114 to create mixed cabin air stream 130. Mixed cabin air stream 130 flows to the air plane cabin 116. Recircuited air 117 exits air plane cabin 116 and enters air compressor 118. Compressed recirculated air 119 exits air compressor 118 and is diverted to air heat exchanger 120 where it is cooled. A water removal membrane (may also be referred to as a humidity membrane) may be located in air heat exchanger 120. Permeate 125 wetter and drier clean recirculated air 124 exits air heat exchanger 120.

Permeate 125 flows through cooling bay 126 and onward to the outflow valve(s) 127, while clean recirculated air 124 enters cabin air mix manifold 114 in order to be blended with cool dry air 131 coming from water extractor 113 located in air conditioning subsystem 201.

FIG. 2 illustrates a block diagram of environmental control system 101 showing the components of air conditioning subsystem 201. Air conditioning subsystem 201 is a standard system found in environmental control systems 101. Additional elements may be located throughout air conditioning subsystem 201. Air conditioning subsystem 201 is designed to cool and dehumidify, if required, engine bleed air 103. Air exits air conditioning subsystem 201 as engine bleed air 103 or cool dry air 131, depending on the location of certain elements. After exiting air conditioning subsystem 201, cool dry air 131 enters cabin air mix manifold 114, whereby clean recirculated air 124 is mixed with cool dry air 131 to form mixed cabin air stream 130.

Air conditioning subsystem 201 is an air cycle machine (ACM), which is the refrigeration unit of the environmental control system. Each ACM and its components are generally referred to as an air conditioning pack. As such, air conditioning subsystem may also be referred to as air conditioning pack herein. Air conditioning subsystem 201 uses engine bleed air as the refrigerant. Air conditioning subsystem 201 comprises multiple components, the main of which are a turbine, compressor, and one or more heat exchangers. The compressor can be any suitable type of compressor but is typically a centrifugal compressor. The turbine can be any suitable type of turbine but is typically an expansion turbine. The heat exchangers can be any suitable type of heat exchangers but are typically air-to-air heat exchangers.

The air enters air conditioning subsystem 201, and first enters first heat exchanger 106. After the air is cooled sufficiently, it enters compressor 107. Compressor 107 compresses engine bleed air 103, thus heating engine bleed air 103. The air then passes through turbine 110, which extracts heat from the air as it expands, cooling it below ambient temperature. The heat removed from the air via turbine 110 is translated into energy to power compressor 107. The air then proceeds to reheater 111, and then through condenser 112 to a water extractor 113 to separate out water and remove it from air conditioning subsystem 201. The air then exits air conditioning subsystem 201 and passes to the cabin air mix manifold 114.

Ducts are located throughout air conditioning subsystem 201, and they move the air from one element to another.

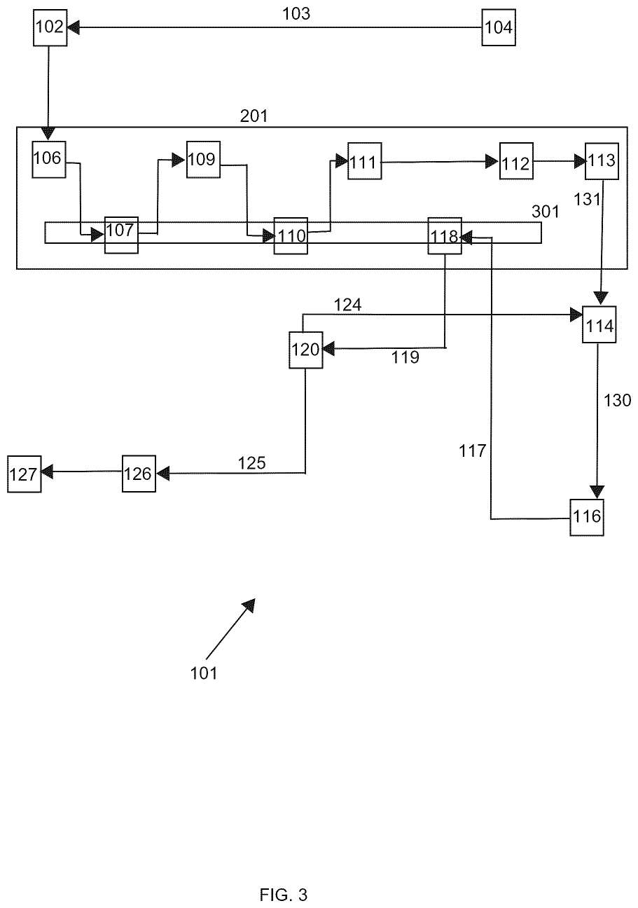

FIG. 3 illustrates a block diagram of an environmental control system 101 showing the components of air conditioning subsystem 201 and shaft 301. Shaft 301 may power air compressor 118 any additional elements of environmental control system and air conditioning subsystem 201, including but not limited to power compressor 107 and turbine 110. Alternatively, compressor 118 may be an electrically driven blower or fan to overcome pressure drop in heat exchanger 120 and to provide pressure differential for water extraction in air heat exchanger 120.

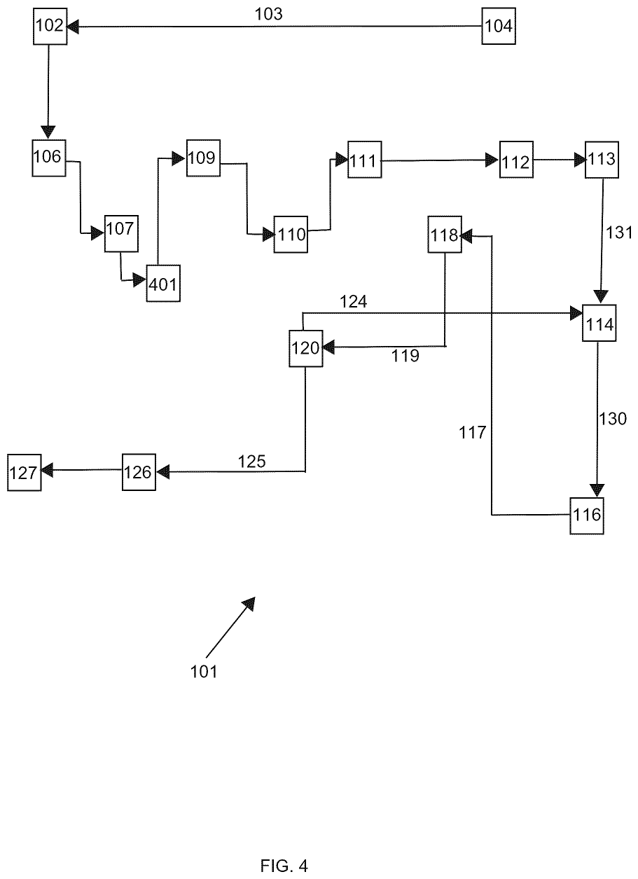

FIG. 4 illustrates a block diagram of environmental control system 101 with VOC and aerosol catalytic converter 401 located in between compressor 107 and the second heat exchanger 109 in environmental control system 101.

Engine bleed air 103 flows from compressor 107 to VOC and aerosol catalytic converter 401 and then on to second heat exchanger 109. VOC and aerosol catalytic converter 401 may be located in air conditioning subsystem 201.

VOC and aerosol catalytic converter 401 is attached with ducting and clamps to compressor 107 and the second heat exchanger 109 capable of withstanding two times the greatest operating pressure. VOC and aerosol catalytic converter 401 may be attached in other methods, as may be required.

VOC and aerosol catalytic converter 401 captures VOC and SVOC from contamination events such as ingestion of exhaust and entrainment of oil leakage, converting the contaminants to smaller molecules that have potentially less odor thresholds, or holding on to some compounds such as organophosphate additives in the aerosol.

The preferred temperature of engine bleed air 103 entering VOC and aerosol catalytic converter 401 in this location is between 250-400 F, and the preferred pressure is between 45-60 PSIA.

VOC and aerosol catalytic converter 401 comprises at least one bed of material consisting of a substrate, a wash coat, and a VOC specific catalyst. The washcoat is porous and provides a high surface area needed for dispersion of the catalytic material, so the particles adhere to the surface of the substrate physically and by molecular bonding to the catalytic materials.

FIG. 5 illustrates a block diagram of environmental control system 101 with VOC and aerosol catalytic converter 401 located in between ozone converter 102 and first heat exchanger 106. This method of scrubbing engine bleed air 103 may be in addition to an existing ozone converter or VOC ozone converter.

VOC and aerosol catalytic converter 401 is attached with ducting and clamps to ozone converter 102 and the first heat exchanger 106 capable of withstanding two times the greatest operating pressure. VOC and aerosol catalytic converter 401 may be attached in other methods, as may be required. Engine bleed air 103 passes through ozone converter 102 whereby the ozone is removed from engine bleed air 103. The de-ozonated engine bleed air 103 then flows through VOC and aerosol catalytic converter 401. VOC and aerosol catalytic converter 401 captures and removes contaminants. Engine bleed air 103 is then released through the rest of environmental control system 101.

Ozone converter 102 and VOC and aerosol catalytic converter 401 are shown as separate elements in FIG. 5; however, VOC and aerosol catalytic converter 401 may take the place of, or be combined with, ozone converter 102 that may already have some level of VOC removal functionality.

The preferred temperature of engine bleed air 103 entering VOC and aerosol catalytic converter 401 in this location is between 250-400 F, and the preferred pressure is between 45-60 PSIA.

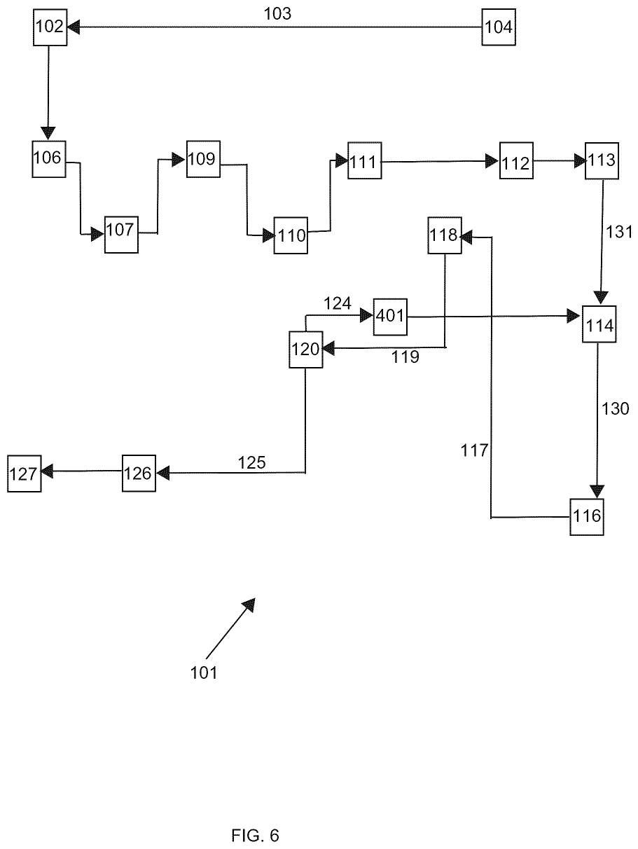

FIG. 6 illustrates a block diagram of environmental control system 101 with VOC and aerosol catalytic converter 401 located in between air heat exchanger 120 and cabin air mix manifold 114.

Air compressor 118, which may be shaft driven or electrically driven, compresses recircuited air 117 to create compressed recirculated air 119. Compressed recirculated air 119 then flows through air heat exchanger 120 to create clean recirculated air 124. Clean recirculated air 124 flows through VOC and aerosol catalytic converter 401. VOC and aerosol catalytic converter 401 captures and removes contaminants from clean recirculated air 124. Air heat exchanger 120 may also include a bed of adsorbent media ahead of VOC and aerosol catalytic converter 401 to capture short-term high-level VOC contaminants and release them at a lower rate for VOC and aerosol catalytic converter 401, which is operating at a lower temperature, to remove. Clean recirculated air 124 is then released into cabin air mix manifold 114, whereby clean recirculated air 124 is mixed with cool dry air 131 to form mixed cabin air stream 130.

Air heat exchanger 120 may contain a water (moisture) removal membrane, a VOC adsorbent, and/or a low temperature VOC catalyst to create clean recirculated air 124.

VOC and aerosol catalytic converter 401 is attached with ducting and clamps to air heat exchanger 120 and cabin air mix manifold 114 capable of withstanding two times the greatest operating pressure. VOC and aerosol catalytic converter 401 may be attached in other methods, as may be required.

The preferred temperature of clean recirculated air 214 entering VOC and aerosol catalytic converter 401 in this location is between 75-100 F, and the preferred pressure is between 8-16 PSIA.

High levels of carbon dioxide may be present in clean recirculated air 124, compressed recirculated air 119, and/or recirculated air 117 stream. A variable speed blower, or other appropriate device/apparatus, with temperature control can drive the rate and where compressed recirculated air 119 is going to flow after entering air heat exchanger 120 and can adjust amount of permeate 125 exiting through the cooling bay 126 to control carbon dioxide below high levels. Permeate 125 flows through cooling bay 126 and onward to the outflow valve(s) 127, while clean recirculated air 124 enters cabin air mix manifold 114 in order to be blended with cool dry air 131 coming from water extractor 113 located in air conditioning subsystem 201. A water removal membrane (may also be referred to as a humidity membrane) may be located in air heat exchanger 120.

Some of clean recirculated air 124, compressed recirculated air 119, and/or recirculated air 117 stream may also be directed to fuel tank inerting systems (FTIS) that are present on aircraft, if so desired.

The various methods of the present invention require an additional element or elements, including specifically the VOC and aerosol catalytic converter 401, to be installed in an environmental control system. Environmental control systems are also commonly known in the field as they are integral parts of commercial aircraft. It would be known by anyone in the field how to connect the VOC and aerosol catalytic converter 401 and any other required parts in an existing environmental control system, or a new environmental control system. Additional elements such as, including but not limited to, pressure control valves, flow meters, computer control and software, sensors, and supply hoses and tubes may be required in order to facilitate the methods of the present invention. Those skilled in the field would have the knowledge of how to properly connect and install VOC and aerosol catalytic converter 401 in an environmental control system in order to perform the methods of the present invention.

Air flow range should typically be from 30 pounds per minute to 150 pounds per minute but can vary based on the aircraft and may also vary based on the location of VOC and aerosol catalytic converter 401 in environmental control system 101. Aircraft engine or APU inlet operating conditions including barometric pressure and temperature, whether on-ground or in-flight, and other factors can affect the pressure, temperature, and flow rate of air through VOC and aerosol catalytic converter 401 to achieve the desired results.

VOC and aerosol catalytic converter 401 removes VOC/SVOC, including, but not limited to phosphate, ultrafine particles which are primarily oil, organo-phosphates, and aldehydes, and other potentially harmful chemicals/substances, from air prior to entering the air plane cabin 116.

While the present invention has been described for use with an aircraft, environmental control system 101 could be utilized in other instances, and as such, VOC and aerosol catalytic converter 401 may be implemented to scrub the air.

VOC and aerosol catalytic converter 401 may be connected/attached to the various pieces in an environmental control system 101 as required by the various methods contained herein. Additional elements/components may be required in order to attach VOC and aerosol catalytic converter 401 to the elements/components, as would be well-known by those skilled in the industry. Based on the location of VOC and aerosol catalytic converter 401, pressure, temperature, flow rates, etc., may be different, and would therefore require different connection elements.

VOC and aerosol catalytic converter 401 may comprise any converter or other device or method that achieves the desired filtering result.

VOC and aerosol catalytic converter 401 may comprise any number of possible components, such as, including, but not limited to, a membrane, a VOC/SVOC aerosol converter (which may be a catalytic converter), a catalyst, an adsorbent, etc., to remove or breakdown or smooth out the contamination with the intent to improve the air quality. The primary function of this element is to further break down VOCs that are released upstream in environmental control system 101.

VOC and aerosol catalytic converter 401 may be implemented in various areas throughout environmental control system 101. Any number of VOC and aerosol catalytic converters 401 may be in environmental control system 101.

Any of the elements of environmental control system 101 may be combined, removed, or moved, and additional elements may be implemented.

There are any number of sensors and other required elements for environmental control system 101 that may be present in the present invention but are not shown herein.

Environmental control system 101 may contain a precooler, which could be modulated to enable the removal of only the amount of excess heat energy to deliver the air to the filter membrane below its heat limit. Typically, it is preferable to retain as much heat energy as possible to drive the air conditioning subsystem 201.

Permeate 125 may comprise approximately more or less than 45% of the return air volume, thus being similar to the total outflow of current designs that do not have additional VOC or CO2 functionality. The addition of shaft driven recirculated air compressor 118 may eliminate the need for electric recirculation blower present on bleeded aircraft.

The methods of the present invention as shown in FIGS. 4-6 reduce the level of carbon dioxide that comes into cabin air mix manifold 114, thus requiring less bleed air to be used, and therefore saving fuel.

The methods of the present invention when used in conjunction with environmental control system 101 reduce the amount of required engine bleed air and increase the amount of recirculated air while reducing and/or improving particulate filtration (smaller, simpler filters that would last longer), which all improve fuel burn efficiency. This results in improved air in the cabin (improved health, lower liability, etc.), reduced fuel burn (less fuel, less costs, greener, etc.), and enhanced component reliability (reduced weight/simplified systems, lower maintenance costs, etc.).

Filter membranes may be located through environmental control system 101 to help control and reduce VOCs, SVOCs, and other compounds. A filter membrane may be located between ozone converter 102 and first heat exchanger 106, but filter membranes may be located through environmental control system 101 and used in conjunction with one or more VOC and aerosol catalytic converters 401 to better control filtration of harmful and/or odorous substances. By placing a filter membrane after ozone converter 102, this allows the membrane filter to remove any organic acids and VOCs that are created during the ozone removal process. Although not specifically shown in the Figures, one or more filter membranes may be located throughout environmental control system 101 and may be used in conjunction with one or more VOC and aerosol catalytic converters 401.

The filter membranes may comprise any filter or other device or method that achieves the desired filtering result. The surface area of any such filter membrane is of adequate area and flow properties such that the surface area prevents excess pressure loss across the filter membrane.

There may be one or more filter membranes located through environmental control system 101. Filter membranes may be any number of types of filter membranes in order to filter out specific substances. Specifically, the primary locations of the membranes that may be present in environmental control system 101 are: a filter membrane, may also be referred to as an oil membrane, a carbon dioxide removal membrane, a humidity membrane, and a bio effluent membrane. These membranes are typically placed either before or in combination with cabin air mix manifold 114.

High levels of carbon dioxide may be present in clean recirculated air 124. The carbon dioxide removal membrane removes the carbon dioxide from clean recirculated air 124 before it enters the cabin air mix manifold 114. In this case, clean recirculated air 124 would flow through the carbon dioxide removal membrane and may bypass the air conditioning subsystem 201.

The humidity membrane removes water from clean recirculated air 124 to ensure there is lower humidity in clean recirculated air 124 before it goes to the cabin air mix manifold 114.

High levels of bio effluents and other human generated VOCs that come from air plane cabin 116 may be present in clean recirculated air 124. The bio effluent membrane removes the bio effluents and other human generated VOCs from clean recirculated air 124 before it enters the cabin air mix manifold 114. In this system, clean recirculated air 124 would flow through the bio effluent membrane and may bypass the air conditioning subsystem 201.

The membranes can be any suitable membranes that achieve the desired results. The membranes selectively allow gas to flow through. Any of the membranes may be combined into one unit or coupled with any other components in air control system 101, including VOC and aerosol catalytic converter 401.

Air control system 101 comprises any number of membranes to remove VOCs, air impurities, and other less desirable compounds in the bleed air and other air streams prior to entering the cabin. The membranes of the present invention could be incorporated within existing environmental control system 101 components or new components could be added to existing environmental control system 101 system or an entirely redesigned environmental control system 101 system could be developed to optimize membrane technology.

Any elements of environmental control system 101 may be removed, duplicated, replaced, moved, etc. One or more VOC and aerosol catalytic converters 401 may be located at any locations in environmental control system 101.

Certain embodiments of the invention have other steps or elements in addition to or in place of those mentioned above. The steps or element will become apparent to those skilled in the art from a reading of the detailed description when taken with reference to the accompanying figures, if any.

The best mode for carrying out the invention has been described herein. The previous embodiments are described in sufficient detail to enable those skilled in the art to make and use the invention. It is to be understood that other embodiments would be evident based on the present disclosure, and that system, process, or mechanical changes may be made without departing from the scope of the present invention.

In the previous description, numerous specific details and examples are given to provide a thorough understanding of the invention. However, it will be apparent that the invention may be practiced without these specific details and specific examples. While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations that fall within the scope of the included claims. All matters previously set forth herein or shown in the accompanying figures are to be interpreted in an illustrative and non-limiting sense.

What is claimed is:

1. A method of scrubbing engine bleed air in an environmental control system, comprising the steps of:
flowing the engine bleed air into an air conditioning subsystem,
wherein the engine bleed air is cooled and compressed; and
flowing the engine bleed air through a volatile organic compounds and aerosol catalytic converter,
wherein the volatile organic compounds and aerosol catalytic converter captures and removes contaminants, and
wherein the engine bleed air is released through the rest of the environmental control system.

2. The method of claim 1, wherein the temperature of the engine bleed air entering the volatile organic compounds and aerosol catalytic converter is between 250-400 F.

3. The method of claim 1, wherein the pressure of the engine bleed air entering the volatile organic compounds and aerosol catalytic converter is between 45-60 PSIA.

4. The method of claim 1, wherein one or more filter membranes are located throughout the environmental control system.

5. A method of scrubbing engine bleed air in an environmental control system, comprising the steps of:
removing ozone in the engine bleed air; and
flowing the engine bleed air through a volatile organic compounds and aerosol catalytic converter,
wherein the volatile organic compounds and aerosol catalytic converter captures and removes volatile, semi-volatile, and ultrafine particle contaminants,
wherein the engine bleed air is released through the rest of the environmental control system.

6. The method of claim 5, wherein the temperature of the engine bleed air entering the volatile organic compounds and aerosol catalytic converter is between 250-400 F.

7. The method of claim 5, wherein the pressure of the engine bleed air entering the volatile organic compounds and aerosol catalytic converter is between 45-60 PSIA.

8. The method of claim 5, wherein one or more filter membranes are located throughout the environmental control system.

9. A method of scrubbing clean recirculated air in an environmental control system, comprising the steps of:
compressing recircuited air via an air compressor to created compressed recirculated air;
flowing the compressed recirculated air through an air heat exchanger that contains a water removal membrane, a volatile organic compounds adsorbent, and a low temperature volatile organic compounds catalyst to create clean recirculated air; and
flowing the clean recirculated air through a volatile organic compounds and aerosol catalytic converter,
wherein the volatile organic compounds and aerosol catalytic converter captures and removes contaminants, and
wherein the clean recirculated air is released back into a cabin air mix manifold.

10. The method of claim 9, wherein the air compressor is shaft driven or electrically driven.

11. The method of claim 9, wherein the temperature of the clean recirculated air entering the volatile organic compounds and aerosol catalytic converter is between 75-100 F.

12. The method of claim 9, wherein the pressure of the clean recirculated air entering the volatile organic compounds and aerosol catalytic converter is between 8-16 PSIA.

13. The method of claim 9, wherein one or more filter membranes are located throughout the environmental control system.
